(19) United States
(12) Patent Application Publication
(10) Pub. No.: US 2015/0021861 A1
(43) Pub. Date: Jan. 22, 2015

(54) ENGINE HAVING PISTON WITH L-SHAPED TIMING RING

(71) Applicant: CATERPILLAR INC., PEORIA, IL (US)

(72) Inventor: Teoman UZKAN, Indian Head Park, IL (US)

(73) Assignee: CATERPILLAR INC., PEORIA, IL (US)

(21) Appl. No.: 14/511,237

(22) Filed: Oct. 10, 2014

Related U.S. Application Data
(62) Division of application No. 13/398,237, filed on Feb. 16, 2012, now abandoned.

(51) Int. Cl. F16J 9/02; F02F 3/24

(52) U.S. Cl. CPC F16J 9/02; F02F 3/24
USPC 277/437

(57) ABSTRACT

An internal combustion engine is disclosed. The engine may have an engine block at least partially defining a cylinder, a liner disposed within the cylinder, and at least a first gas exchange port passing through an annular surface of the liner. The engine may also have a cylinder head connected to the engine block and together with the liner forming a combustion chamber, and at least a second gas exchange port disposed within the cylinder head in fluid communication with the combustion chamber. The engine may additionally have a piston slidably disposed within the liner and having an annular groove formed within an outer surface, and a plurality of piston rings selectively connectable with the annular groove. Each of the plurality of piston rings may be generally L-shaped and have a different axial length. Each of the plurality of piston rings is selected to vary an opening and closing timing of the at least a first gas exchange port.

### TECHNICAL FIELD

The present disclosure relates generally to an engine and, more particularly, to an engine having an L-shaped ring used to control timing of an associated port.

### BACKGROUND

Conventional two-stroke engines include a cylinder, a cylinder head connected to the cylinder to at least partially form a combustion chamber, and a piston disposed within the combustion chamber. At least one port, for example an intake port, is formed within a liner of the cylinder to allow gas exchange with the combustion chamber each time the piston moves downward within the cylinder. The piston is provided with annular grooves and rings disposed within the grooves.

The piston rings perform several different functions, including sealing a radial gap between the piston and cylinder liner so as to maintain high gas pressures within the combustion chamber, maintaining lubrication between the piston and cylinder liner, and maintaining an axial position of the piston relative to the cylinder liner during reciprocation of the piston. In ported engines, the top-most of the piston rings also acts as an intake valve, opening and closing the intake port to charge the combustion chamber with fresh air.

For strength reasons associated with the annular grooves, the top-most piston ring is positioned a fixed axial distance below a face of the piston. This position, however, results in a crevice located radially between the piston and cylinder liner and axially between the top-most piston ring and the face of the piston. In some applications, the size of this crevice can have negative consequences on engine performance and emission characteristics. Further, the fixed nature of the top-most piston ring may limit timing opportunities of the intake port.

One attempt to address the problems described above is disclosed in U.S. Pat. No. 5,908,013 that issued to Dyess on Jun. 1, 1999 (the '013 patent). Specifically, the '013 patent discloses a loop-scavenging, two-stroke engine having a piston with an L-shaped top ring. The L-shaped top ring includes a leg that extends into an associated piston crevice.

Although the engine of the '013 patent may have a piston crevice partially occupied by the L-shaped top ring, it may still be problematic. In particular, the L-shaped top ring may create excessive friction against the associated cylinder liner, and be prone to leakage between the ring and the piston. In addition, the '013 patent doesn't disclose a way to vary the timing of an associated intake port.

The disclosed engine is directed to overcoming one or more of the problems set forth above and/or other problems of the prior art.

### SUMMARY

In one aspect, the present disclosure is directed to a piston ring. The piston ring may include a flange portion having a central opening and an outer surface concentric with the central opening. The piston ring may also include a lip portion disposed at the outer surface of the flange portion and extending in an axial direction away from the flange portion. The piston ring may additionally include a single contact portion extending radially outward from an axial distal end of the lip portion.

In another aspect, the present disclosure is directed to an internal combustion engine. The internal combustion engine may include an engine block at least partially defining a cylinder, a liner disposed within the cylinder, and at least a first gas exchange port passing through an annular surface of the liner. The internal combustion engine may also include a cylinder head connected to the engine block and together with the liner forming a combustion chamber, and at least a second gas exchange port disposed within the cylinder head in fluid communication with the combustion chamber. The internal combustion engine may additionally include a piston slidably disposed within the liner and having an annular groove formed within an outer surface. The annular groove may be configured to selectively receive a plurality of piston rings. Each of the plurality of piston rings may be generally L-shaped and have a different axial length. Each of the plurality of piston rings may be selected to vary an opening and closing timing of the at least a first gas exchange port.

In yet another aspect, the present disclosure is directed to method of adjusting valve timing in a two-stroke engine. The method may include removing a first ring in a top groove of a piston, the first ring being generally L-shaped and having a first axial length. The method may further include installing a second ring in the top groove of the piston, the second ring being generally L-shaped and having a second axial length different than the first axial length.

### BRIEF DESCRIPTION OF THE DRAWINGS

FIG. 1 is a diagrammatic illustration of an exemplary disclosed engine;

FIG. 2 is a diagrammatic illustration of an exemplary disclosed piston that may be used in conjunction with the engine of FIG. 1; and

FIGS. 3-5 are diagrammatic illustrations of exemplary disclosed rings that may be used in conjunction with the piston of FIG. 2.

### DETAILED DESCRIPTION

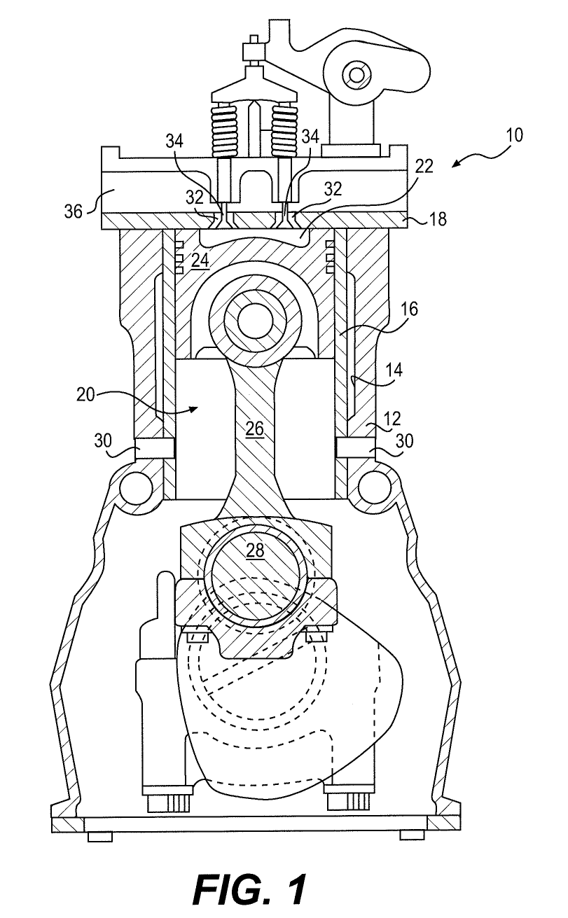

An exemplary internal combustion engine 10 is illustrated in FIG. 1. Engine 10 is depicted and described as a two-stroke diesel engine. However, it is contemplated that internal combustion engine 10 may be another type of internal combustion engine such as, for example, a four-stroke diesel engine, a two or four-stroke gasoline engine, or a two- or four-stroke gaseous fuel-powered engine. Engine 10 may include, among other things, an engine block 12 that at least partially defines a cylinder 14, a liner 16 disposed within cylinder 14, and a cylinder head 18 connected to engine block 12 to close off an end of liner 16. A piston 20 may be slidably disposed within liner 16 and, together with liner 16 and cylinder head 18, define a combustion chamber 22. It is contemplated that the engine 10 may include any number of combustion chambers 22 and that combustion chambers 22 may be disposed in an “in-line” configuration (shown in FIG. 1), in a “V” configuration, in an opposing-piston configuration, or in any other conventional configuration.

Piston 20 may be configured to reciprocate between a bottom-dead-center (BDC) or lower-most position within liner 16, and a top-dead-center (TDC) or upper-most position. In particular, piston 20 may be an assembly that includes a piston crown 24 pivotally connected to a rod 26, which may in turn be pivotally connected to a crankshaft 28. Crankshaft 28 of engine 10 may be rotatably disposed within engine block 12 and each piston 20 coupled to crankshaft 28 by rod 26 so that a sliding motion of each piston 20 within liner 16 results in a rotation of crankshaft 28. Similarly, a rotation of the crankshaft 28 may result in a sliding motion of piston 20. As crankshaft 28 rotates through about 180 degrees, piston crown 24 and connected rod 26 may move through one full stroke between BDC and TDC. Engine 10, being a two-stroke engine, may have a complete cycle that includes a power/exhaust/intake stroke (TDC to BDC) and an intake/compression stroke (BDC to TDC).

During a final phase of the power/exhaust/intake stroke described above, air may be drawn into combustion chamber 22 via one or more gas exchange ports (e.g., intake ports) 30 located within an annular surface 31 of liner 16. In particular, as piston 20 moves downward within liner 16, a position will eventually be reached at which intake ports 30 are no longer blocked by piston 20 and instead are fluidly communicated with combustion chamber 22. When intake ports 30 are in fluid communication with combustion chamber 22 and a pressure of air at intake ports 30 is greater than a pressure within combustion chamber 22, air will pass through intake ports 30 into combustion chamber 22. The timing at which intake ports 30 are opened (i.e., unblocked by piston 20 and fluidly communicated with combustion chamber 22) may have an effect on a pressure gradient between intake ports 30 and combustion chamber 22 and/or an amount of air that passes into combustion chamber 22 before intake ports 30 are subsequently closed by the ensuing upward movement of piston 20. The opening and/or closing timings of intake ports 30 may also have an effect on a temperature of the air directed into combustion chamber 22. Fuel may be mixed with the air before, during, or after the air is drawn into combustion chamber 22.

During the beginning of the intake/compression stroke described above, air may still be entering combustion chamber 22 via intake port 30 and piston 20 may be starting its upward stroke to mix the fuel and air within combustion chamber 22. Eventually, intake port 30 may be blocked by piston 20 and further upward motion of piston 20 may compress the mixture. As the mixture within combustion chamber 22 is compressed, a temperature of the mixture will increase. Eventually, the pressure and temperature of the mixture will reach a point at which the mixture combusts, resulting in a release of chemical energy in the form of temperature and pressure spikes within combustion chamber 22.

During a first phase of the power/exhaust/intake stroke, the pressure spike within combustion chamber 22 may force piston 20 downward, thereby imparting mechanical power to crankshaft 28. At a particular point during this downward travel, one or more gas exchange ports (e.g., exhaust ports) 32 located within cylinder head 18 may open to allow pressurized exhaust within combustion chamber 22 to exit. In particular, as piston 20 moves downward within liner 16, a position will eventually be reached at which exhaust valves 34 move to fluidly communicate combustion chamber 22 with exhaust ports 32. When combustion chamber 22 is in fluid communication with exhaust ports 32 and a pressure of exhaust in combustion chamber 22 is greater than a pressure within exhaust ports 32, exhaust will pass from combustion chamber 22 through exhaust ports 32 into an exhaust manifold 36. The timing at which exhaust valves 34 move to open exhaust ports 32 may have an effect on a pressure gradient between combustion chamber 22 and exhaust ports 32 and/or an amount of exhaust that passes from combustion chamber 22 before exhaust ports 32 are subsequently closed by exhaust valves 34. The opening and/or closing timings of exhaust ports 32 may also have an effect on a temperature within combustion chamber 22. In the disclosed embodiment, movement of exhaust valves 34 may be cyclical and controlled by way of a cam (not shown) that is mechanically connected to crankshaft 28. It is contemplated, however, that movement of exhaust valves 34 may be controlled in any other conventional manner, as desired. It is also contemplated that exhaust ports 32 could alternatively be located within cylinder liner 16, if desired, such as in a loop scavenged two-cycle engine.

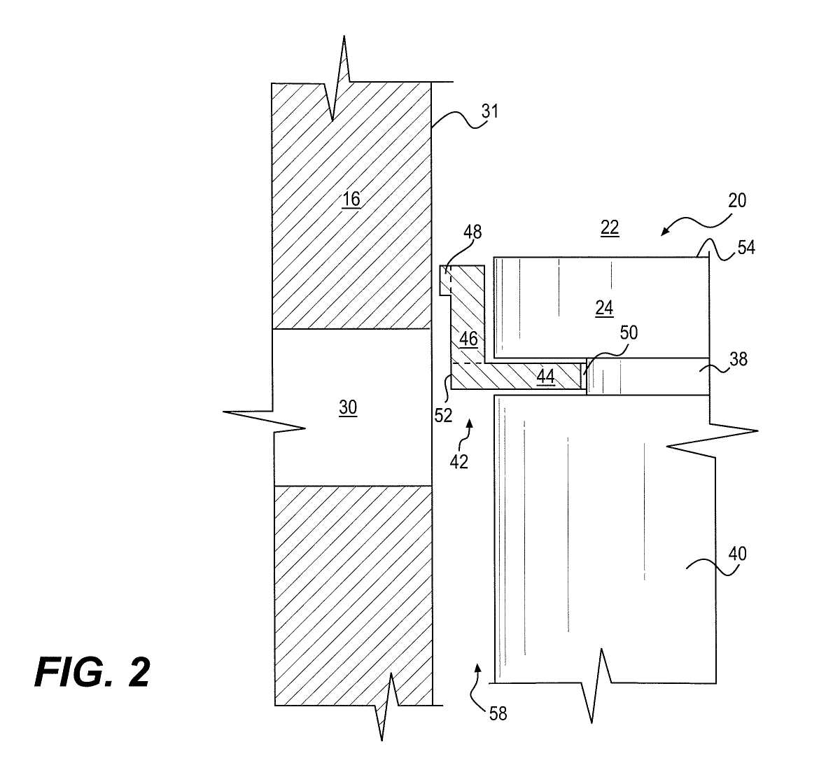

As shown in FIG. 2, piston crown 24 may have a generally cylindrical structure with one or more grooves 38 formed within an outer annular surface 40. Grooves 38 may be configured to receive any number of piston rings including, for example, one or more oil or scraper rings, one or more compression rings, and/or another type of piston ring known in the art. For purposes of simplicity, FIG. 2 illustrates only a single groove 38 holding only one ring 42 (e.g., a compression ring). It should be noted, however, that most applications will require a greater number and type of piston rings.

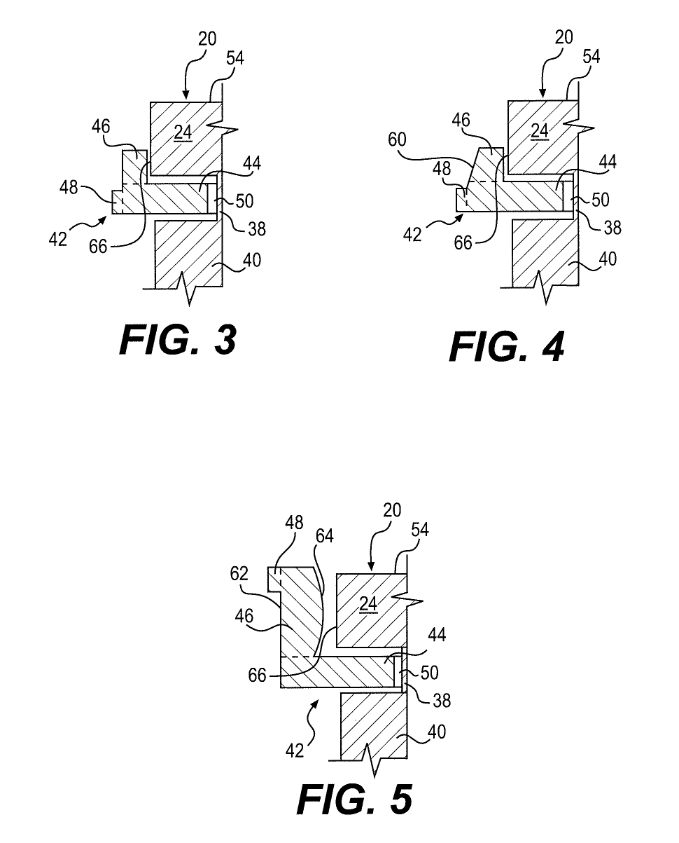

Ring 42 may be generally L-shaped and include a flange portion 44, an axial lip portion 46, and a single contact portion 48. Flange portion 44 may be generally flat and include a central opening 50 and an outer annular surface 52 that is generally concentric with central opening 50. Central opening 50 may have a diameter greater than an inner diameter of the associated groove 38, but less than an outer diameter of piston crown 24 such that flange portion 44 may be retained at least partially within groove 38 by a difference in diameters. Lip portion 46 may be located at outer annular surface 52 and extend axially away from flange portion 44 (e.g., toward a top face 54 of piston crown 24). Contact portion 48 may extend radially outward away from an axial end of flange portion 44 to engage inner annular surface 31 of liner 16. In the embodiment of FIG. 2, contact portion 48 has a thickness about the same as a thickness of flange portion 44 and extends from a distal end of lip portion 46 to enhance a sealing performance of ring 42. In the embodiment of FIG. 3, however, contact portion 48 has a thickness less than a thickness of flange portion 44 and extends from a proximate end of lip portion 46 to enhance a strength of ring 42. It should be noted that contact portion 48 could be thicker than flange portion 44, if desired.

Flange portion 44, lip portion 46, and contact portion 48 may together form an integral open-ended component. In particular, ring 42 may include ends (not shown) that are spaced apart from each other to facilitate assembly of ring 42 within groove 38. To install ring 42 within groove 38, the ends of ring 42 may first be pushed apart from each other to temporarily enlarge the diameter of central opening 50. While the diameter of central opening 50 is temporarily enlarged, ring 42 may be placed over piston crown 24 and into axial alignment with groove 38. The ends of ring 42 may then be released, allowing ring 42 to flex into and be retained within groove 38 by the now smaller diameter of central opening 50.

The location and geometry of ring 42 may affect the opening and closing timings of intake port 30. In particular, lip portion 46 of ring 42 may extend an axial distance into a crevice 58 formed annularly between piston crown 24 and inner annular surface 31 of liner 16 and axially between ring 42 and top face 54 of piston crown 24. In this arrangement, lip portion 46 may inhibit fluid exchange between intake port 30 and combustion chamber 22. However, as piston 20 moves downward within liner 16, lip portion 46 may eventually move below intake port 30, thereby establishing fluid communication between intake port 30 and combustion chamber 22 via crevice 58. Accordingly, an axial length of lip portion 46 may control opening and closing timings of intake port 30 relative to the motion of piston 20. For example, for a given movement of piston 20, a shorter lip portion 46 may result in an earlier and longer exposure of intake port 30 to combustion chamber 22 via crevice 58. Likewise, a longer lip portion 46 may result in a later and shorter exposure of intake port 30 to combustion chamber 22 via crevice 58. In fact, it may even be possible for lip portion 46 to have an axial length the same as or greater than a distance between groove 38 and top face 54 of piston crown 24 such that fluid communication via crevice 58 is not even possible and air flows directly from intake port 30 into combustion chamber 22. In this manner, ring 42 may function as a timing ring for engine 10 that can be selectively replaced with another ring 42 having a different axial dimension to adjust opening and closing timings of intake port 30.

FIG. 4 illustrates an alternative embodiment of ring 42. Like the embodiment of FIG. 2, ring 42 of FIG. 4 may include flange portion 44, lip portion 46, and contact portion 48. However, in contrast to the embodiment of FIG. 2, lip portion 46 of FIG. 4 may include an inclined outer surface 60. Inclined outer surface 60 may gradually transition contact portion 48 into lip portion 46, thereby increasing a strength of contact portion.

FIG. 5 illustrates another alternative embodiment of ring 42. Like the embodiment of FIG. 2, ring 42 of FIG. 5 may include flange portion 44, lip portion 46, and contact portion 48. However, in contrast to the embodiment of FIG. 2, lip portion 46 of FIG. 5 may include a generally flat outer surface 62 that is parallel with an inner surface 56 of liner 16, and a generally convex inner surface 64 located opposite outer surface 62. Convex inner surface 64 may create a seal against an outer annular surface 66 of piston crown 24 that inhibits and/or controls back-leakage from combustion chamber 22 between ring 42 and piston crown 24.

### Industrial Applicability

The disclosed engine and piston ring may be used in any application where fine control over valve timing independent of piston top or top ring groove location is beneficial. In particular, the ability to adjust valve timing in a two-cycle engine through the use of unique piston rings may allow tuning of an existing engine without requiring major redesign. That is, the engine may retain the majority of its existing components and even maintain about the same compression ratio, yet still be able to change the timings and/or amounts at which the engine's ports are opened and closed. These changes in port opening/closing timing and amounts may help an existing engine to improve emissions and meet ever-changing regulations. In addition, fuel consumption and/or power capacity may also be enhanced with timing changes.

To adjust the opening and closing timings and/or amounts in the disclosed two cycle engine, a service technician need only replace existing piston rings with piston rings having a different axial lip dimension. For example, the technician may install a first ring 42 within groove 38 (i.e., the top groove) of piston 20. As piston 20 moves downward within liner 16, first ring 42 may eventually move past intake port 30 to communicate intake port 30 with combustion chamber 22 via crevice 58 at a first opening timing. Further downward movement of piston 20 may increase an area of fluid communication between intake port 30 and combustion chamber 22 until a first maximum area is obtained and piston 20 reverses direction. As piston 20 returns upward within liner 16, first ring 42 may eventually move into the fluid communication path between intake port 30 and combustion chamber 22, thereby inhibiting gas exchange therebetween at a first closing timing. The first opening timing, the first maximum flow area, and the first closing timing may all be related to the axial lip dimension of first ring 42 and result in a first performance of engine 10.

The service technician may then replace first ring 42 with a second ring 42 having a second axial lip dimension different than the axial lip dimension of first ring 42. As piston 20 moves downward within liner 16, second ring 42 may eventually move past intake port 30 to communicate intake port 30 with combustion chamber 22 via crevice 58 at a second opening timing. Further downward movement of piston 20 may increase an area of fluid communication between intake port 30 and combustion chamber 22 until a second maximum area is obtained and piston 20 reverses direction. As piston 20 returns upward within liner 16, second ring 42 may eventually move into the fluid communication path between intake port 30 and combustion chamber 22, thereby inhibiting gas exchange therebetween at a second closing timing. The second opening timing, the second maximum flow area, and the second closing timing may all be related to the axial lip dimension of second ring 42 and result in a second performance of engine 10. It should be noted that, in some embodiments, the second maximum area may be the same as the first maximum area, even though the opening and closing timings may be different.

The disclosed design of ring 42 may help reduce friction generated at liner 16 by making sliding surfaces of ring 42 smaller. In particular, because only contact portion 48 of ring 42 may contact liner 16, the amount of friction generated therebetween may be low while still allowing ring 42 to radially position piston crown 24 within liner 16.

The disclosed design of ring 42 may help to improve fluid sealing at crevice 58. For example, the convex shape at inner surface 64 may engage outer annular surface 66 of piston crown 24 to create a seal that reduces back-flow. In addition, the high gas pressures within combustion chamber 22 may act on the inner surface of lip portion 46, causing lip portion 46 to deflect outward against the lower pressure within crevice 58, thereby causing contact portion 48 to engage liner 16 and create a seal that inhibits front-flow past ring 42.

It will be apparent to those skilled in the art that various modifications and variations can be made to the disclosed engine and piston ring. Other embodiments will be apparent to those skilled in the art from consideration of the specification and practice of the disclosed engine. It is intended that the specification and examples be considered as exemplary only, with a true scope being indicated by the following claims and their equivalents.

1-20. (canceled)

21. A piston ring, comprising:
a flange portion having a central opening and an outer surface concentric with the central opening, the flange portion being configured to be retained at least partially within a groove formed in an outer annular surface of a piston;
a lip portion disposed at the outer surface of the flange portion and extending in an axial direction away from the flange portion, wherein the lip portion of the piston ring is configured to extend past a top face of the piston; and
a single contact portion extending radially outward from an axial end of the lip portion.

22. The piston ring of claim 21, wherein:
the single contact portion of the piston ring extends radially outward from a proximate end of the lip portion; and
the single contact portion of the piston ring has a thickness different than a thickness of the flange portion of the piston ring.

23. The piston ring of claim 21, wherein the lip portion of the piston ring includes: a flat outer surface facing a liner within which the piston moves; and a convex inner surface facing the piston.

24. The piston ring of claim 21, wherein the piston ring is an open-ended component capable of flexure in a radial direction.
